(19) United States
(12) Patent Application Publication
(10) Pub. No.: US 2026/0197903 A1
(43) Pub. Date: Jul. 9, 2026

(54) ELECTRICALLY HEATABLE FLUID LINE FOR A COMPONENT OF AN ELECTROCHEMICAL ENERGY CONVERTER, SYSTEM FOR AN ELECTROCHEMICAL ENERGY CONVERTER AND ELECTROCHEMICAL ENERGY CONVERTER

(71) Applicant: Robert Bosch GmbH, Stuttgart (DE)

(72) Inventors: Guido Bernd Finnah, Weissach (DE); Guido Stammsen, Stuttgart (DE); Joerg Engelhardt, Ditzingen (Hirschlanden) (DE)

(21) Appl. No.: 19/134,352

(22) PCT Filed: Nov. 14, 2023
(86) PCT No.: PCT/EP2023/081721

§ 371 Date: May 30, 2025

(30) Foreign Application Priority Data
Dec. 12, 2022 (DE) 10 2022 213 474.5

(51) Int. Cl. H05B 3/12

(52) U.S. Cl. CPC H05B 3/12

(57) ABSTRACT

The invention relates to an electrically heatable fluid line (10) for a component (11) of an electrochemical energy converter, said fluid line being made of a plastic (14) which is mixed with electrically conductive particles (13), having an outer lateral surface (15) and an inner lateral surface (16), and having at least one first electrical contact (17) and at least one second electrical contact (18), wherein the at least one first electrical contact (17) and the at least one second electrical contact (18) are arranged on the outer lateral surface (15) in a mutually spaced manner.

### BACKGROUND

Heating pipes through which a fluid/medium flows is a common application. The lines of nozzles, injection valves, mixers, pumps, tanks, water separators, and many other components must be heated to thaw the media they contain and thus make them conveyable or to heat them to a certain temperature level for subsequent processes without evaporating.

It has been shown that it is advantageous to use the lines/pipes to heat the guided media, since these have a large surface area and the heat can be applied well from the outside. Various heating techniques can be used, such as electrical resistance heating elements, combustion or heat exchangers.

The electric resistance heaters can consist of simple metallic conductors, e.g. cables of appropriate length wound around the pipe, PTC heating elements based on ceramics, or even electrically conductive plastics.

### SUMMARY

The invention relates to an electrically heatable fluid line, a system and an electrochemical energy converter according to the disclosure. Further features and details of the invention arise from the claims, the description, and the drawings. The features and details described in connection with the electrically heatable fluid line according to the invention naturally also apply in connection with the system according to the invention and/or in connection with the electrochemical energy converter according to the invention, and vice versa in each case, so that mutual reference is or can be made with regard to the disclosure of the individual aspects of the invention.

An electrically heatable fluid line for a component of an electrochemical energy converter, made of a plastic material mixed with electrically conductive particles, with an outer lateral surface and an inner lateral surface, and with at least one first electrical contact and at least one second electrical contact, wherein the at least one first electrical contact and the at least one second electrical contact are arranged on the outer lateral surface in a mutually spaced manner.

The electrically heatable fluid line is used to warm up or thaw a fluid in an electrochemical energy converter, such as a fuel cell or an electrolyzer. The fluid may have frozen, e. g. due to the outside temperatures, and must be thawed after a cold start so that the lines of an electrochemical energy converter can be used again or so that valves of an electrochemical energy converter can switch again. This is the case, for example, in the water traps of an electrochemical energy converter or on the drain or metering valves of an electrochemical energy converter. The fluid remaining and frozen in front of or in valves can cause malfunctions.

To thaw the fluid, the first and second electrical contacts are connected to electricity and the wall of the electrically heatable fluid line is thus passed through with electricity, whereby the electrically conductive particles cause the electrically heatable fluid line to heat up (Joule heating). This heat is transferred to the internal fluid/medium, i.e. to the fluid flowing in the electrically heatable line, and this is thawed or at least warmed up.

In this case, the inner lateral surface can be in direct contact with the fluid. The fluid can be, for example, deionized water. Deionized water is not or only slightly electrically conductive, so that no current flows through the deionized water, but the current flows through the electrically heatable fluid line. In the case of electrochemical energy converters in particular, electrolysis may also occur to a small extent. This would cause hydrogen to be produced from the water, which is present in the system anyway and can react again in the electrochemical energy converter and be converted back into electricity.

The electrically heatable fluid line can be round, square or oval, depending on the component. In addition, it can be straight and/or curved to guide the fluid to its destination. This allows the electrically heatable fluid line to be adapted to different geometries.

It is particularly advantageous if at least one of the electrical contacts is arranged on the outer lateral surface in the area of the end side. This allows the heat generated to be transferred to other elements that are or may be connected to the fluid line.

In the context of the invention, it can be advantageous for an electrically heatable fluid line if the electrically conductive particles are arranged in sections in the axial direction or over a length of the fluid line and/or in sections in the radial direction or over a circumference of the fluid line.

The heat is generated due to the resistance that the electrically conductive particles offer to the current. Accordingly, the distribution and quantity of the electrically conductive particles determine the location or area at which the heat is generated and transferred to the fluid.

By arranging the electrically conductive particles in sections in the axial or radial direction, the heat effect in the electrically heatable fluid line and its strength can be determined in a targeted manner. Furthermore, it is possible to equip only certain areas of an electrically heatable fluid line with electrically conductive particles. This is easily implemented due to the production of this electrically heatable fluid line by injection molding.

By arranging the electrically conductive particles over a length of the fluid line, i.e. the entire length of the fluid line, the entire fluid line can be heated in a simple manner to ensure that the various areas and undercuts are heated.

In the context of the invention, it is conceivable that the electrically conductive particles in an electrically heatable fluid line are soot and/or graphite and/or metal powder and/or metal fibers and/or carbon nanotubes.

A high level of electrical conductivity is achieved by adding a sufficient number of electrically conductive particles. Specific electrical conductivities can also be set to adjust the internal resistance in the electrically heatable fluid line and thus the power consumption.

Furthermore, a PTC effect (Positive Temperature Coefficient) can be caused in the plastic of the electrically heatable fluid line by the different thermal expansion coefficients of the plastic material and the fillers when heated, so that a temperature-dependent self-regulating effect can limit the power consumption of the tubular heating element and prevent overheating.

In the context of the invention, it may be provided in the case of an electrically heatable fluid line that the at least one first electrical contact and the at least one second electrical contact are arranged radially and/or axially offset from one another.

This allows the area in the electrically heatable fluid line in which the heat is generated to be defined.

If the at least two electrical contacts are attached radially on the outer diameter of the electrically heatable fluid line, the current flows from the first electrical contact over the circumferential segment to the next contact, that is, the second electrical contact. In this case, the at least one first electrical contact can be arranged at an angle to the second electrical contact.

The angle can be between 45° and 180°, preferably between 90° and 180°, more preferably 135° and 180°.

If the at least two electrical contacts are arranged on the outer diameter of the electrically heatable fluid line in the axial pipe direction at a distance from one another, the current flows along the electrically heatable fluid line. Even with an axial arrangement of the electrical contacts, these can be arranged radially offset from one another.

According to the invention, it is conceivable that the at least one first electrical contact and/or the at least one second electrical contact have a contacting layer for making contact with one another, wherein the contacting layer is a conductive adhesive and/or sprayed-on metal particles and/or an encapsulated metallic cable and/or a stamping grid.

The use of conductive adhesive and/or sprayed-on metal particles and/or encapsulated metallic cables and/or stamping grids ensures both the electrical contacting of the electrically heatable fluid line and the local connection of the electrically heatable fluid line. A conductive adhesive is an electrically conductive adhesive.

The transmission of the current via the contact layer can be ensured by means of an insulation displacement connection and/or spring contacts and/or a stamping grid with plug.

In an electrically heatable fluid line, it is also conceivable that the at least one first electrical contact and/or the at least one second electrical contact has/have a contact surface, wherein the contact surface extends partially, in particular completely, along the length in the axial direction of the electrically heatable fluid line and/or along the circumference in the radial direction of the outer lateral surface of the electrically heatable fluid line.

The size of the contact surface for connecting the electrical contacts to the electrically heatable fluid line can in turn be used to control or determine the area in the electrically heatable fluid line in which the heat is generated and the heat generated. Accordingly, certain circumferential segments of the electrically heatable fluid line in which heat is to be generated can be determined in a simplified manner. Furthermore, this also allows the path of the heat along the electrically heatable fluid line to be determined.

In the present case, “extending partially along the circumference” means that the contact surface corresponds to at least 5%, preferably at least 25%, more preferably at least 50%, more preferably at least 75%, of the circumference of the outer lateral surface of the electrically heatable fluid line.

In the context of the invention, it is optionally possible, in the case of an electrically heatable fluid line, for at least one at least partially, in particular completely, circumferential outer undercut to be provided on the outer lateral surface of the electrically heatable fluid line.

The at least one outer undercut is suitable for accommodating seals, for example O-rings, in order to seal the electrically heatable fluid line with respect to other components.

Furthermore, the outer undercut can be a fastening means which is designed to accommodate a counter-fastening means of a further component, for example another fluid line or a valve.

If the electrically heatable fluid line is installed in a housing or another component, the at least one outer undercut can also serve as a positioning aid when installing it in the housing.

In the case of an electrically heatable fluid line, it is also conceivable that at least one, preferably at least two, at least partial, in particular complete, circumferential inner undercut is provided on the inner lateral surface.

The inner undercut serves to accommodate or connect other components or further fluid lines. This allows for a simple media-tight connection.

Preferably, the inner undercut is located on one of the end sides of the electrically heatable fluid line. This makes it easy to create a contact surface for a sealing seat.

It is conceivable that an anti-rotation device is provided on the outer lateral surface of the electrically heatable fluid line. This ensures the fixed position of the electrically heatable fluid line when it is installed in another component or housing of an electrochemical energy converter. The anti-rotation device can, for example, be a protrusion on the outer lateral surface of the electrically heatable fluid line.

In addition, a pipe, in particular a metal pipe, can be arranged along the inner lateral surface of the electrically heatable fluid line and is connected to the plastic, which is mixed with electrically conductive particles, via the inner lateral surface in a heat-transferring manner.

In this case, it is particularly advantageous if the pipe or the material of the pipe has a high heat transfer coefficient, as this optimizes and accelerates the transfer of heat to the fluid.

Furthermore, the pipe, especially the metallic pipe, is anodized and/or coated to produce electrical and/or chemical insulation.

It is conceivable that further heat-conducting elements made of the same electrically conductive plastic or of mounted metal elements are provided to conduct the heat that has arisen in the pipe to other areas in a targeted manner. For example, a metal pin can be arranged so that the pin extends from the electrically conductive plastic or the mounted metal elements into a discharge pipe. This can also thaw a more distant area and restore the functionality of the entire system.

The above-mentioned task is also solved by an electrochemical energy converter system according to the invention, with an electrically heatable fluid line and a component as described above, wherein the component and the electrically heatable fluid line are in contact with one another, in particular in heat-transferring contact.

In this context, being in contact means that the heat generated in the electrically heatable fluid line influences the component. That is to say, the electrically heatable fluid line and the component are in direct contact with each other or the fluid that is heated in the electrically heatable fluid line releases this heat to the component.

Furthermore, in the context of the invention, it may be provided in a system that an outer undercut of the outer lateral surface of the electrically heatable fluid line is a fastening means and that the component has a counter-fastening means, wherein, for fastening the component to the electrically heatable fluid line, the counter-fastening means engages in the fastening means.

This ensures that the component is securely connected to the electrically heatable fluid line. This connection is preferably designed to be releasable. The connection can be a snap-in connection or a clip connection. For this purpose, the area of the fastening means can be designed to be resilient.

In a system, it is conceivable that the component and the electrically heatable fluid line are arranged in a housing.

The housing is a common housing. This makes the electrically heatable fluid line easy to handle, i.e. it can be arranged on the component inside the housing, for example, and in particular fixed to it.

In the context of the invention, it is conceivable for the system that the component is a valve, wherein the valve has a valve housing with a counter-fastening means and a movable valve stopper, which in the closed state makes contact with a completely circumferential inner undercut of the inner lateral surface of the heatable fluid line.

The contact of the valve stopper with the inner lateral surface of the heatable fluid line can ensure the mobility of the valve stopper at low temperatures or, if the fluid has frozen, restore it.

The above task is also solved by an electrochemical energy converter according to the invention with at least one electrically heatable fluid line as described above and/or a system as described above. The electrochemical energy converter is preferably a fuel cell or an electrolyzer or a fuel cell system or an electrolyzer system.

Further advantages, features, and details of the invention follow from the description hereinafter, in which multiple exemplary embodiments of the invention are described in detail with reference to the drawings. In this context, the features mentioned in the claims and in the description can each be essential to the invention individually or in any combination. The invention is illustrated in the following drawings:

### BRIEF DESCRIPTION OF THE DRAWINGS

FIG. 1 a schematic illustration of an electrically heatable fluid line,

FIG. 2 a schematic illustration of an arrangement of the electrical contacts,

FIG. 3 a schematic illustration of a second arrangement of the electrical contacts,

FIG. 4 a schematic illustration of a first exemplary embodiment of the system,

FIG. 5 a schematic illustration of a second exemplary embodiment of the system, and

FIG. 6 a schematic illustration of an electrochemical energy converter.

### DETAILED DESCRIPTION

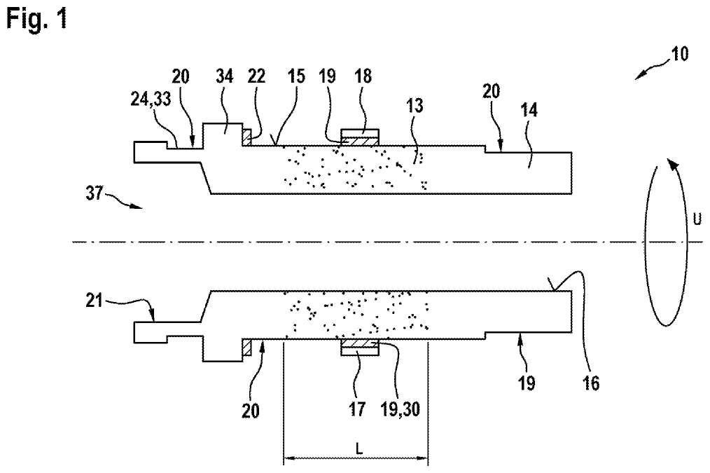

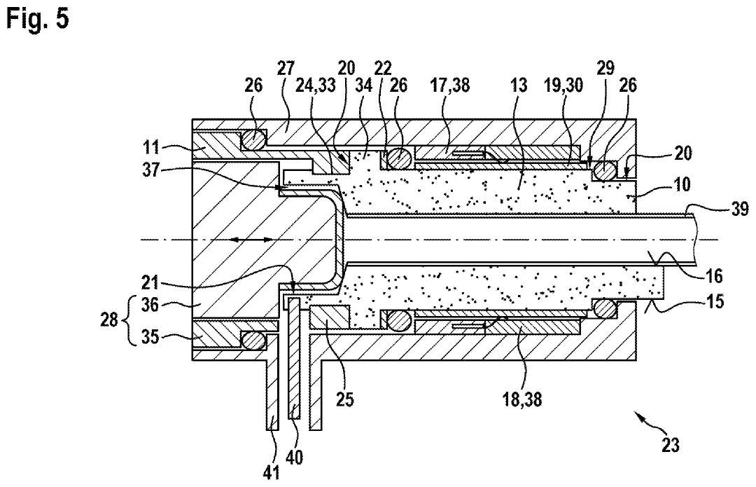

FIG. 1 shows an electrically heatable fluid line 10 for a component 11 of an electrochemical energy converter (12), which is shown in FIG. 5 in schematic form, made of a plastic 14 mixed with electrically conductive particles 13. The electrically heatable fluid line 10 has an outer lateral surface 15 and an inner lateral surface 16 as well as at least one first electrical contact 17 and at least one second electrical contact 18. The at least one first electrical contact 17 and the at least one second electrical contact 18 are arranged on the outer lateral surface 15 in a mutually spaced manner.

The electrically conductive particles 13 are arranged in the present case in a section of length L in the axial direction of the electrically heatable fluid line 10 and in the radial direction over a circumference U of the electrically heatable fluid line 10. The electrically conductive particles 13 are soot and/or graphite and/or metal powder and/or metal fibers and/or carbon nanotubes.

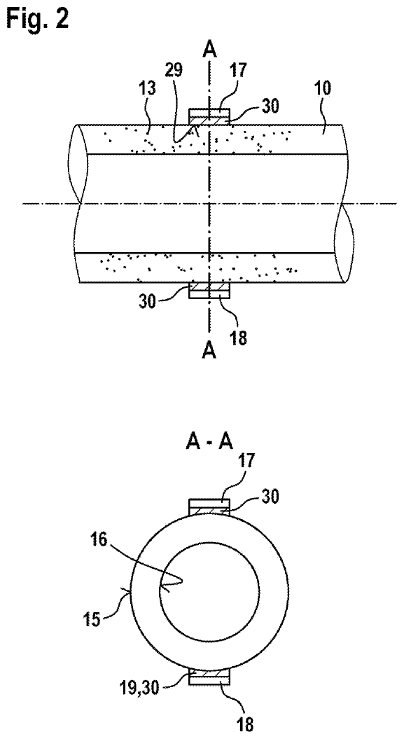

According to the exemplary embodiment of FIGS. 1 and 2, the at least one first electrical contact 17 and the at least one second electrical contact 18 are arranged radially offset from one another on the outer lateral surface 15 of the electrically heatable fluid line 10, in this example, for example, at an angle of 180° between the first and second electrical contacts 17, 18. In this case, the two contacts 17, 18 are offset in the axial direction with respect to one another. Both the at least one first electrical contact 17 and the at least one second electrical contact 18 have a contact surface 29, wherein the contact surface 29 is square and extends partially along the length L in the axial direction and along the circumference U in the radial direction of the outer lateral surface 15. The length of the contact surface 29 on the circumferential side corresponds to approximately 5% of the circumference U.

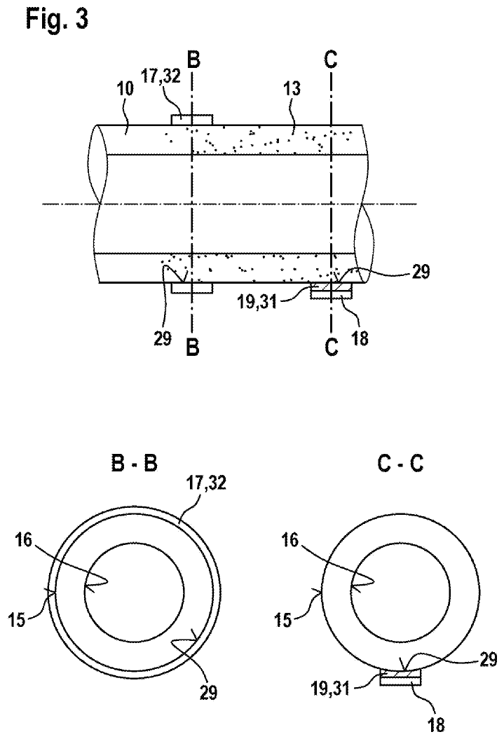

In an exemplary embodiment according to FIG. 3, the at least one first electrical contact 17 and the at least one second electrical contact 18 are arranged axially and radially offset with respect to one each other. The at least one first electrical contact 17 and/or the at least one second electrical contact 18 has/have a contact surface 29, wherein the contact surface 29 extends partially, in particular completely, along the length L in the axial direction and/or along the circumference U in the radial direction of the outer lateral surface 15. In this case, the at least one first electrical contact 17 extends along the entire circumference U and the second electrical contact 18 extends partially along the circumference U. The circumferential extent of the second electrical contact 18 corresponds to approximately 10% of the circumference U of the electrically heatable fluid line 10.

The at least one first electrical contact 17 and/or the at least one second electrical contact 18 of the first exemplary embodiment of FIGS. 1 and 2 have a contacting layer 19 for making contact, wherein the contacting layer 19 is preferably a conductive adhesive 30. In the second exemplary embodiment, metal particles 31 were sprayed on to make contact with the second electrical contact 18. The at least one first electrical contact 17 is preferably an encapsulated metallic cable 32. In the exemplary embodiment according to FIG. 5, the contacts 17, 18 are spring contacts 38.

At least one outer undercut 20, which runs at least partially, in particular completely, around the outer lateral surface 15 of the electrically heatable fluid line 10, is provided. In this case, one of the outer undercuts 20 is designed as a circumferential groove 33, which serves as a fastening means 24. Another outer undercut 20 serves as a section in which the electrically conductive particles 13 are distributed, and thus as a contact surface for the contact surfaces 29. Furthermore, contact surfaces for seals 26 are provided on the outer undercuts 20. Furthermore, the outer undercuts 20 either provide a positioning aid 34 themselves or enclose a positioning aid 34 between them.

In the present case, a completely circumferential inner undercut 21 is provided on the inner lateral surface 16. This is provided in an area of an end side 37 of the electrically heatable fluid line 10 in order to be able to accommodate a component 11, for example a valve 28 or a seal 26, as shown in FIG. 5.

Furthermore, the electrically heatable fluid line 10 according to FIG. 1 has an anti-rotation device 22 on the outer lateral surface 15.

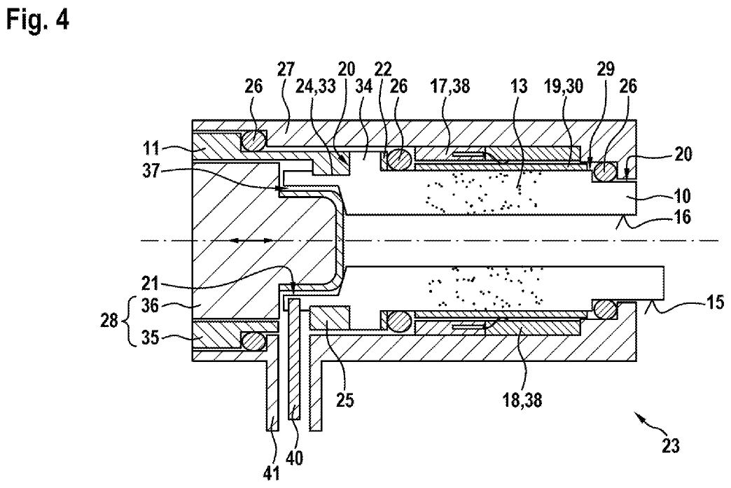

In FIG. 4 and FIG. 5, a system for an electrochemical energy converter 12 is shown with an electrically heatable fluid line 10 according to FIGS. 1 to 3 and a component 11. In this case, the component 11 and the electrically heatable fluid line 10 are in contact with one another, in particular in heat-transferring contact.

In this case, the outer undercut 20 of the outer lateral surface 15 of the electrically heatable fluid line 10 can serve as a fastening means 24, as shown in FIG. 4. In addition, the component 11 has a counter-fastening means 25. In this case, the counter-fastening means 25 engages in the spring-elastic fastening means 24 to fasten the component 11 to the electrically heatable fluid line 10. This can be designed as a kind of clip or snap-in connection.

For better handling, the component 11 and the electrically heatable fluid line 10 are arranged in a housing 27. For this, it is advantageous if the component 11 and the electrically heatable fluid line 10 are already connected and the seals 26 are positioned on the grooves 33 or outer undercuts 20 provided for this purpose and then inserted into the housing 27. It would also be conceivable to insert it into one half of the housing 27, wherein a second half of the housing is then placed on top and screwed in place. Positioning aids 34 are provided for positioning a component 11 on the electrically heatable fluid line 10 or the electrically heatable fluid line 10 in a housing 27.

In the exemplary embodiment according to FIG. 4 and FIG. 5, the component 11 is a valve 28. The valve 28 has a valve housing 35 with a counter-fastening means 25 and a movable valve stopper 36, which in the closed state is in contact with a completely circumferential inner undercut 21 of the inner lateral surface 16 of the electrically heatable fluid line 10.

Furthermore, a metallic pin 40 is arranged on the electrically heatable fluid line 10 such that the heat from the plastic 14 mixed with electrically conductive particles 13 is transferred to a discharge pipe 41 of the fluid.

In the second exemplary embodiment according to FIG. 5, a metallic pipe 39 is arranged in the electrically heatable fluid line 10 along the inner lateral surface 16 and is connected to the plastic 14, which is mixed with electrically conductive particles 13, in a heat-transferring manner via the inner lateral surface 16. In the exemplary embodiment, the electrically conductive particles 13 are distributed over the entire length of the electrically heatable fluid line 10 in order to heat the undercut 21 as well, whereby, for example, freezing or partial freezing of the valve stopper is prevented.

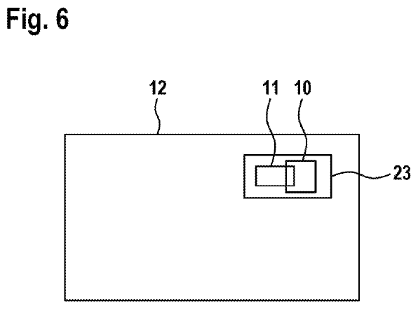

FIG. 6 shows an electrochemical energy converter 12 with at least one electrically heatable fluid line 10 according to FIGS. 1 to 3 and/or a system 23 according to FIG. 4. The electrochemical energy converter 12 can be a fuel cell system or an electrolyzer system.

1. An electrically heatable fluid line (10) for a component (11) of an electrochemical energy converter, said fluid line being made of a plastic (14) which is mixed with electrically conductive particles (13), having an outer lateral surface (15) and an inner lateral surface (16), and having at least one first electrical contact (17) and at least one second electrical contact (18), wherein the at least one first electrical contact (17) and the at least one second electrical contact (18) are arranged on the outer lateral surface (15) in a mutually spaced manner.

2. The electrically heatable fluid line (10) according to claim 1,
wherein
the electrically conductive particles (13) are arranged in sections in the axial direction or over a length (L) of the fluid line (10) and/or in sections in the radial direction or over a circumference (U) of the fluid line (10).

3. The electrically heatable fluid line (10) according to claim 1,
wherein
the electrically conductive particles (13) are soot and/or graphite and/or metal powder and/or metal fibers and/or carbon nanotubes.

4. The electrically heatable fluid line (10) according to claim 1,
wherein
the at least one first electrical contact (17) and the at least one second electrical contact (18) are arranged radially and/or axially offset from one another.

5. The electrically heatable fluid line (10) according to claim 1,
wherein
at least one first electrical contact (17) and/or at least one second electrical contact (18) have a contacting layer (19) for making contact with one another, wherein the contacting layer (19) is a conductive adhesive and/or sprayed-on metal particles and/or encapsulated metallic cables and/or stamping grids.

6. The electrically heatable fluid line (10) according to claim 1,
wherein
at least one first electrical contact (17) and/or at least one second electrical contact (18) has a contact surface (29), wherein the contact surface (29) extends along the length (L) in the axial direction and/or along the circumference (U) in the radial direction of the outer lateral surface (15).

7. The electrically heatable fluid line (10) according to claim 1,
wherein
at least one circumferential outer undercut (20) is provided on the outer lateral surface (15).

8. The electrically heatable fluid line (10) according to claim 1,
wherein
at least one circumferential inner undercut (21) is provided on the inner lateral surface (16).

9. The electrically heatable fluid line (10) according to claim 1,
wherein
an anti-rotation device (22) is provided on the outer lateral surface (15).

10. The electrically heatable fluid line (10) according to claim 1,
wherein
a pipe (39) is arranged along the inner lateral surface (16) and is connected to the plastic (14) mixed with electrically conductive particles (13) via the inner lateral surface (16) in a heat-transferring manner.

11. A system (23) for an electrochemical energy converter (12) having an electrically heatable fluid line (10) according to claim 1 and a component (11), wherein the component (11) and the electrically heatable fluid line (10) are in contact with one another.

12. The system (23) according to claim 11,
wherein
an outer undercut (20) of the outer lateral surface (15) of the electrically heatable fluid line (10) is a fastening means (24) and that the component (11) has a counter-fastening means (25), wherein, for fastening the component (11) to the electrically heatable fluid line (10), the counter-fastening means (25) engages in the fastening means (24).

13. The system (23) according to claim 11,
wherein
the component (11) and the electrically heatable fluid line (10) are arranged in a housing (27).

14. The system (23) according to claim 11,
wherein
the component (11) is a valve (28), wherein the valve (28) has a valve housing (35) with a counter-fastening means (25) and a movable valve stopper (36) which, in the closed state, makes contact with a fully circumferential inner undercut (21) of the inner lateral surface (16) of the heatable fluid line (10).

15. An electrochemical energy converter (12) with at least one electrically heatable fluid line (10) according to claim 1.
